(19) United States
(12) Patent Application Publication
(10) Pub. No.: US 2002/0076684 A1
(43) Pub. Date: Jun. 20, 2002

(54) Computer-based learning system

(76) Inventors: Donna J. Blevins, Greenville, TN (US); Jack L. Gilbert, Brentwood, TN (US)

Correspondence Address: Bryan W. Bockhop, Esq., BOCKHOP & REICH, LLP, Bldg. 400, Suite 300, 3235 Satellite Blvd., Duluth, GA, 30096, US

(21) Appl. No.: 09/738,682

(22) Filed: Dec. 15, 2000

(51) Int. Cl. G09B 3/00; G09B 7/00

(52) U.S. Cl. 434/322

(57) ABSTRACT

In a method of providing early childhood education, a computerized presentation is presented on a computer screen to a supervisor of a student that sets forth at least one tutorial relating to a computerized interactive lesson. The tutorial includes: a recitation of a set of learning patterns developed by the computerized interactive lesson; a recitation of a methodology used to develop the set of learning patterns to be followed in presenting the computerized interactive lesson, wherein the recitation indicates actions to be followed by the supervisor in interacting with the student during the presentation of the computerized interactive lesson; and a recitation of a set of instructions that describe a set of events occurring in the computerized interactive lesson. The computerized interactive lesson is presented only after the supervisor has completed the computerized presentation. The system continuously determines an accumulated amount of time that the supervisor and the student have had access to the computerized interactive lesson. If the accumulated amount of time exceeds a predetermined threshold, then the system ceases to allow access by the supervisor and the student to the computerized interactive lesson.

### BACKGROUND OF THE INVENTION

1. Field of the Invention

The present invention relates to computer systems and, more specifically, to computer-based educational systems for early childhood development.

2. Description of the Prior Art

Recent neurological research has indicated that many neural functions develop during critical stages of a person's development, with many of the critical stages occurring during a person's early childhood development phase. For example, it has been found that a person will speak a foreign language with an accent unless the person was taught the foreign language during the first several years of the person's existence. Similarly, other important cognitive abilities seem to develop to a higher level if they are first exercised during early childhood. One hypothesis for this result is that neural connections become fixed at certain stages of a child's development and, if a set of connections corresponding to a particular cognitive skill set is developed before the connections become fixed, then the child will have advanced abilities relating to the cognitive skill set.

To take advantage of this phenomenon, some early childhood education programs teach children basic skills, such as character recognition, numbers and manual dexterity. One traditional method of early childhood education includes teaching via flash cards, while others methods include presenting lessons via computer. Although such methods may have a positive effect if used correctly, many parents fail to restrain themselves in presenting early childhood education and drill the child with lessons. Drilling tends to cause the child to loose interest in the lesson and may even cause the child to develop a negative attitude toward learning.

Therefore, there is a need for an early childhood educational tool that is interesting to the child, that rewards the child and that prevents drilling of the child.

### SUMMARY OF THE INVENTION

The disadvantages of the prior art are overcome by the present invention which, in one aspect, is a method of providing early childhood education in which a computerized presentation is presented on a computer screen to a supervisor of a student that sets forth at least one tutorial relating to a computerized interactive lesson. The tutorial includes a recitation of a set of learning patterns developed by the computerized interactive lesson, a recitation of a methodology used to develop the set of learning patterns to be followed in presenting the computerized interactive lesson that indicates actions to be followed by the supervisor in interacting with the student during the presentation of the computerized interactive lesson, and a recitation of a set of instructions that describe a set of events occurring in the computerized interactive lesson. The computerized interactive lesson is presented only after the supervisor has completed the computerized presentation. The system continuously determines an accumulated amount of time that the supervisor and the student have had access to the computerized interactive lesson. If the accumulated amount of time exceeds a predetermined threshold, then the system ceases to allow access by the supervisor and the student to the computerized interactive lesson.

In another aspect, the invention is a method of preventing drilling of a computer-based lesson, in which an accumulated amount of time that a user has had access to the computer-based lesson is determined. If the accumulated amount of time is less than a predetermined threshold, then the computer-based lesson is presented to the user, otherwise the user is restricted from accessing the computer-based lesson.

In yet another aspect, the invention is a method of administering computer-based lesson presentment in which a request for an computer-based lesson is received from a user via the global computer network. A current use timer having a timer value is reset and the timer value is periodically incremented. An accumulated use memory, having an accumulator value is accessed. If the accumulator value is not less than a predetermined value, then the user is restricted from accessing the computer-based lesson. If the accumulator value is less than the predetermined value, then the following steps are performed repetitively: the computer-based lesson is presented to the user, the accumulator value is set to the accumulator value plus the timer value, and it is determined if the accumulator value is not less than the predetermined value. If the accumulator value is not less than the predetermined value then the computer-based lesson is ended and the user is restricted from accessing the computer-based lesson.

The invention provides the user with a multi-sensory process that stimulates various areas of the student's brain during the period when developmental windows of opportunity are open. The stimulated areas include the areas that control the following skills: vocabulary, math and logic; music; spacial and visual arts; motor; emotional and social; and second languages.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic drawing of a computer network that may be employed with one embodiment of the invention.

FIG. 2 is a flowchart illustrating a time keeping system employed in one embodiment of the invention.

FIG. 3 is an illustration of a plurality of computer screens employed in a first exemplary lesson provided in one embodiment of the invention.

FIG. 4 is an illustration of a plurality of computer screens employed in a second exemplary lesson provided in one embodiment of the invention.

FIG. 5 is an illustration of a plurality of computer screens employed in a third exemplary lesson provided in one embodiment of the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

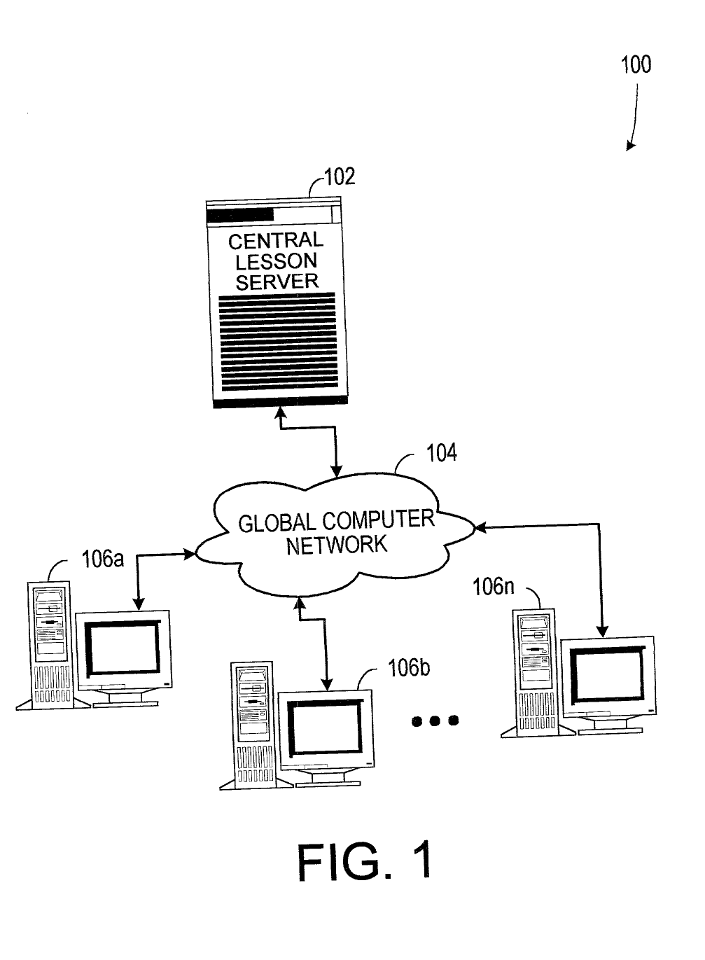

As shown in FIG. 1, one embodiment of the invention may be run on a distributed computer system 100 that includes a central lesson server 102 in communication with a global computer network 104, which is in communication with a plurality of local computers 106a-n. A supervisor, such as a parent, initiates operation of the invention by logging on to the central lesson server 102 from one of the local computers. Once logged on, the supervisor and a student, such as the supervisor's child, will have access to a plurality of lessons directed to early childhood education.

Initially, the supervisor downloads a lesson module from the central lesson server 102 via the global computer network 104. The system requires the supervisor to complete an overview of the training program. The overview goes over some of the basic principles and theory employed by the system in early childhood education. Once the supervisor has completed the overview, the supervisor is presented with a tutorial relating to the specific lesson module to which the supervisor and the child will have access. The tutorial includes: a recitation of a set of learning patterns developed by the lesson; a recitation of a methodology used to develop the set of learning patterns; and a recitation of a set of instructions that describe a set of events occurring in the computerized interactive lesson. The system may also present a list of instructions relating to the computerized interactive lesson immediately prior to the presenting step each time the presenting step is executed. Once the supervisor has completed all of the tutorials relating to the modules in a lesson, then the supervisor and the student are granted access to the individual lessons included in a lesson module.

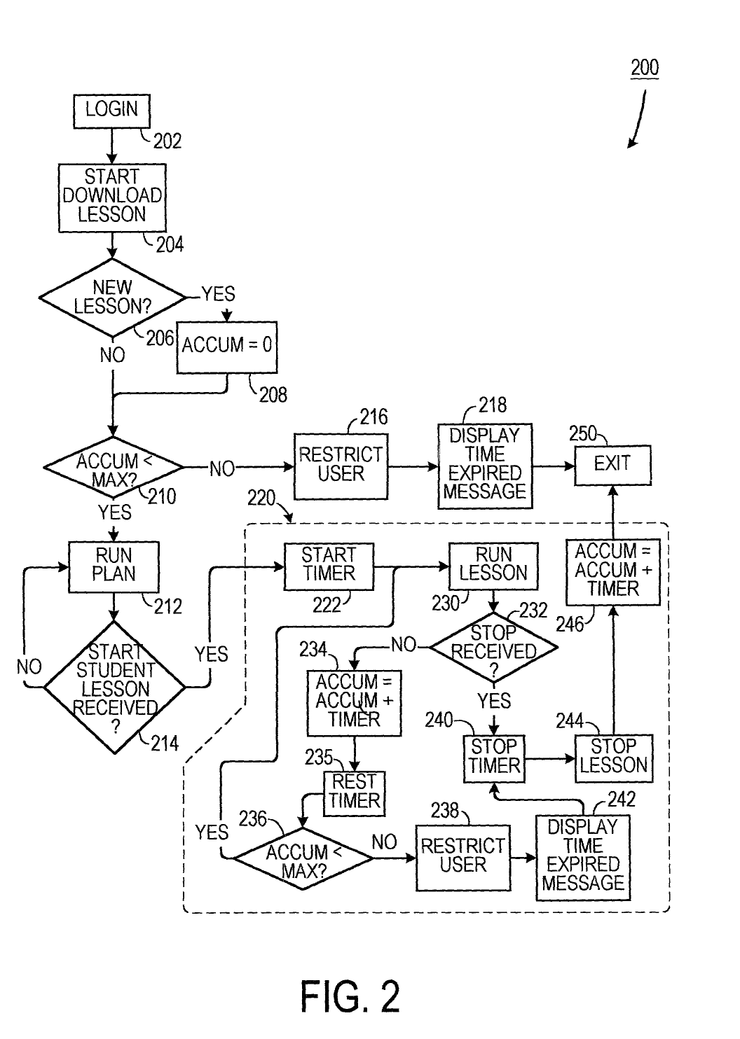

In presenting the lesson, the system continuously determines the accumulated amount of time that the supervisor and the student have had access to the computerized interactive lesson. If the accumulated amount of time exceeds a predetermined threshold (e.g., one hour), then the system prevents access by the supervisor and the student to the computerized interactive lesson. This prevents the supervisor from drilling the student with a lesson, thereby causing the student to want to reject the lesson. This may be done, as shown in FIG. 2, through use of a timer routine 200. Once the supervisor has successfully logged in 202 and a lesson is downloaded 204, the system performs a test 206 to determine if a new lesson has been downloaded. If so, the value of an accumulator for that lesson is set to zero 208. Otherwise, control passes to a test 210 that determines if the value in the accumulator is less than a maximum (corresponding to the threshold). If the accumulator has a value at least as high as the maximum, then the system restricts the user from accessing the lesson 216, displays a message indicating that the user's time has expired 218 and exits 250 from the lesson. The supervisor must then wait until a new lesson download becomes available. Typically, a new lesson package will be made available each week.

If, on the other hand, the value of the accumulator is less than the threshold, the system will run 212 the desired lesson plan. The system waits 214 until the user desires to start the lesson and, once started, starts a timer 222 and runs 230 the desired lesson. The system continuously tests 232 for an indication from the user that the user desires to stop the lesson and, if no stop is received, adds the current value of the timer to the value of the accumulator and resets 235 the timer. The system then determines 236 if the value of the accumulator is less than the maximum. If so, control returns to the run lesson block 230 and the lesson continues. Otherwise, the timer is stopped 240, the lesson is stopped 244, the value of the timer is added to the accumulator 246 and the system exits 250 from the lesson. If the system detects at decision 232 that the user has requested a stop of the lesson, the timer is stopped 240, the lesson is stopped 244, the value of the timer is added to the accumulator 246 and the system exits 250 from the lesson.

The system could also display on the computer screen the amount of time remaining available to the student. This amount would equal the maximum minus the value stored in the accumulator.

As an example, a lesson that is used to develop speech, motor skills and size conception could cause a balloon of a predetermined color to appear when the child and the supervisor press the letter on the keyboard corresponding to the first letter of a color. Pressing the up arrow key could cause the most recently displayed balloon to expand until the balloon pops, at which time an image of a clown appears as an entertaining reward to the child. In such a case, the lesson tutorial would present a listing of the learning patterns developed that could include the following:

Gain a conceptual understanding of colors, sizes and shapes.

Develop speech.

Develop motor skills.

Learn to follow directions.

Increase attention span.

Develop keyboarding skills.

Make a pointer finger.

Build self-confidence.

The methodology provided could include the following list:

Red, Purple, Yellow, Blue and Green balloons will pop up on the screen when the beginning letter of the color is pressed.

Hold down the letter key to make balloons of that color.

By pressing the up arrow key, the balloon will pop.

After a balloon pops, a reward occurs.

The instruction portion of the tutorial could include the following list:

Choose one color at a time.

Take your child's pointer finger and press the first letter of the color on the keyboard.

R: Red—P: Purple—Y: Yellow—B: Blue—G: Green.

After several balloons of the same color are on the screen, move your child's pointer finger to the up arrow key. Press and hold down the up arrow key until balloon pops.

After 2 or 3 colors, point to the letter on the keyboard. Say, “Press here,” several times to see if your child will press the key him/herself. If not, move your child's finger to the key.

Say the letters, sounds of the letters and colors.

“R, RRR (sound), R is for Red,” or “R sounds like a growling dog, RRR.”

Say “Up, up, up,” while inflating the balloon.

In the beginning, it is important for the parent/teacher to pick colors to be made. It helps structure the child.

Praise the child. Clap!

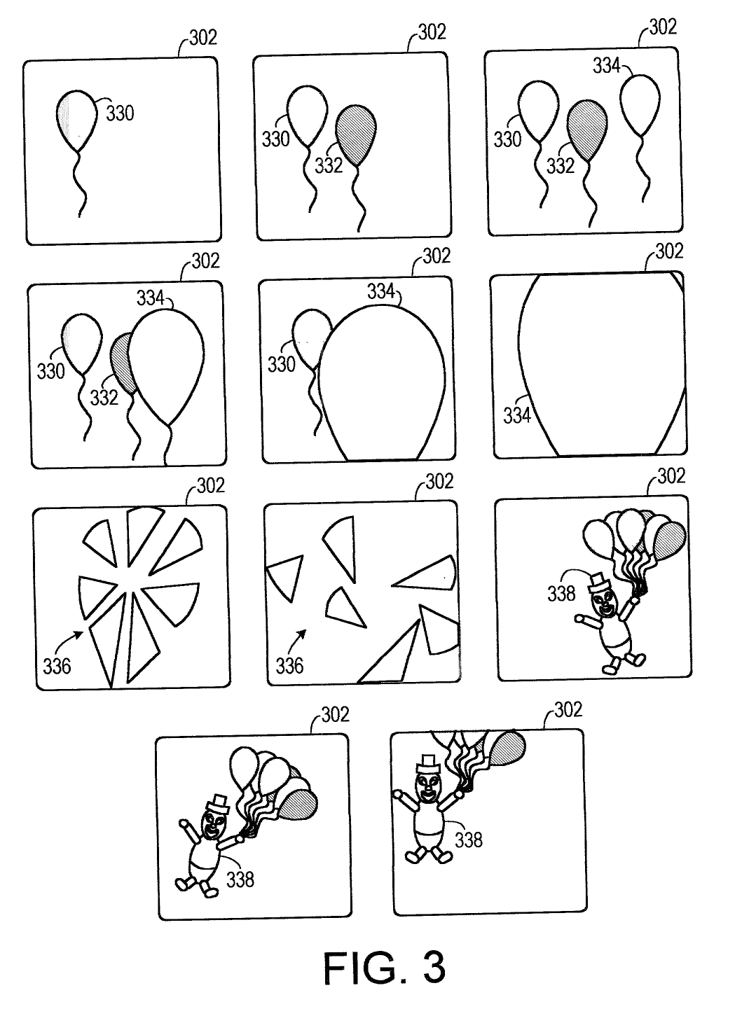

As shown in FIG. 3, this lesson example would progress as follows: after the student pressed a key corresponding to the first letter of a color (e.g., “G” for green), an image of a green balloon 330 would appear on the first screen 302. The student could then press another letter for another color and a balloon 332 of the second color would appear on the screen 302. The same could be true for a third balloon 334 of a third color. Once the student has produced a desired number of balloons, the “UP” arrow key is pressed and the balloon begins to expand until it covers a predetermined portion of the screen. Then an animation of a balloon popping 336 is displayed. During the balloon expansion phase, an audio clip corresponding to expansion of a balloon could also be output by the computer. An image of a clown 338 being lifted by a plurality of balloons may be displayed as an entertaining reward to the student, a short amusing tune may also be output by the computer to reinforce the entertainment value associated with the lesson.

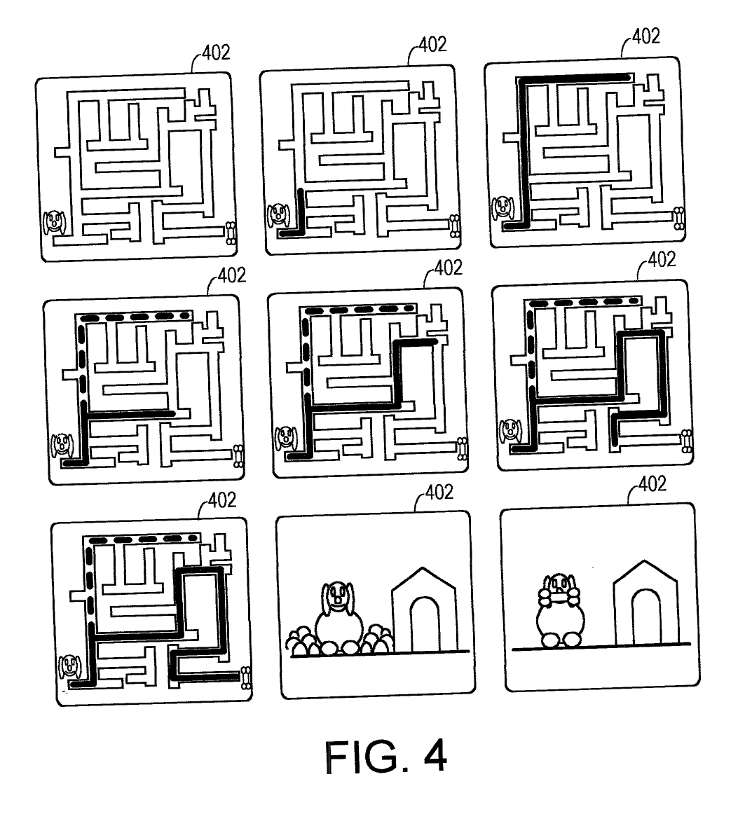

Another example of a lesson that may be presented is shown in FIG. 4. This computerized interactive lesson is directed to teaching keyboard usage. Initially, an image of a maze is displayed on the screen 402. At the beginning, a sound object could say “Doggie has lost his bone. Help Doggie find his bone.” The maze could define a starting point, such as a starting location of a dog, and an ending point, such as an image of a bone. The lesson could begin with an audio instruction such as “Help doggie find his bone.” An image of the dog, a progressive colored line, or both could be used to show progress through the maze as the student presses arrow keys. Once the student reaches the end of the maze, the system could recognize success with an animation or an audio exclamation, or both. For example, the system could output a sequence of sounds that say “Good! Now help doggie dig up his bone.” The computerized audio clip comprising the sequence of sounds could employ any one of the many computerized audio conventions known to the computer software art (e.g., using “.wav” technology). The system would then display an animation of a dog digging for a bone next to a dog house as an entertaining reward to the student.

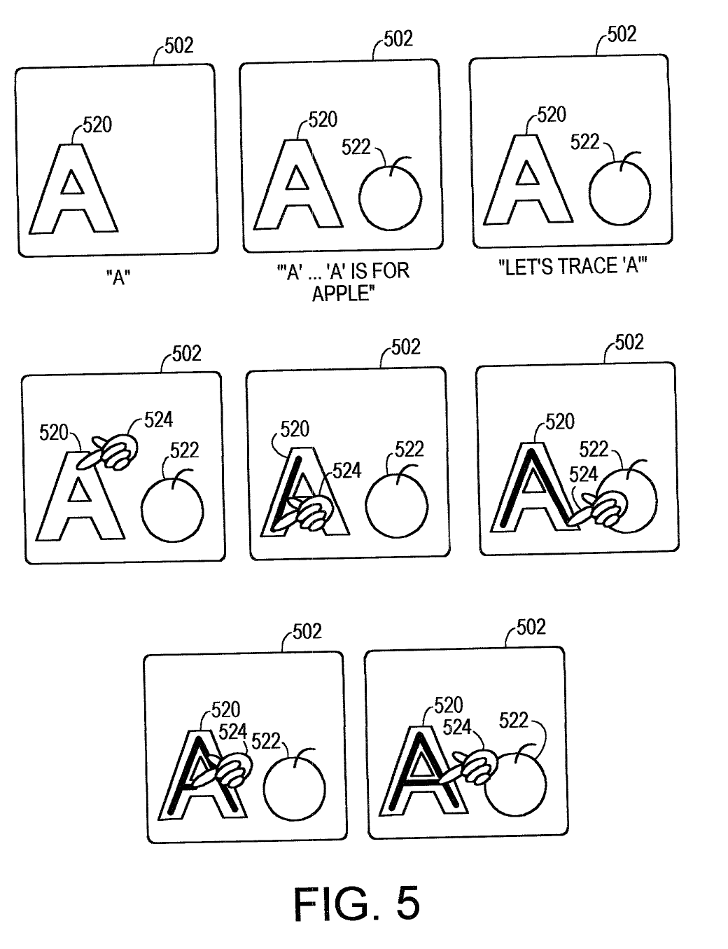

Yet another example of a lesson could be one directed to teaching letters. As shown in FIG. 5, in this example a letter 520 is displayed on the screen 502 and the name of the letter is spoken via computer speakers. An object 522 having a name that begins with the letter 520 is then displayed. The name of the letter and the object are both spoken and then the student is instructed to trace the letter 520. An image of a hand 524 may then demonstrate the tracing of the letter 520.

While the above description discloses three examples of lessons that may be presented by the system, it will be understood that many other lessons may be created within the scope of the invention.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A method of providing early childhood education, comprising the steps of:
a. presenting, on a computer screen, a computerized presentation to a supervisor of a student that sets forth at least one tutorial relating to a computerized interactive lesson, the tutorial including:
i. a recitation of a set of learning patterns developed by the computerized interactive lesson;
ii. a recitation of a methodology used to develop the set of learning patterns to be Followed in presenting the computerized interactive lesson, wherein the recitation indicates actions to be followed by the supervisor in interacting with the student during the presentation of the computerized interactive lesson; and
iii. a recitation of a set of instructions that describe a set of events occurring in the computerized interactive lesson;
b. presenting the computerized interactive lesson only after the supervisor has completed the computerized presentation; and
c. continuously determining an accumulated amount of time that the supervisor and the student have had access to the computerized interactive lesson and if the accumulated amount of time exceeds a predetermined threshold, then ceasing to allow access by the supervisor and the student to the computerized interactive lesson.

2. The method of claim 1, wherein the presenting step comprises the step of downloading the computer-based lesson from a central server to a local computer via a global computer network.

3. The method of claim 2, wherein the presenting step further comprises the step of running the computer-based lesson locally on the local computer.

4. The method of claim 1, further comprising the step of presenting a list of instructions relating to the computerized interactive lesson immediately prior to the presenting step each time the presenting step is executed.

5. The method of claim 1, wherein the computerized interactive lesson is directed to teaching letters and wherein the presenting step comprises the steps of:
a. presenting a first image of a selected letter on the computer screen;
b. presenting a first computerized audio clip of the name of the selected letter and a word that begins with the selected letter;
c. presenting an image on the computer screen relating to the word;
d. presenting a second computerized audio clip instructing the student to trace the selected letter;
e. presenting an animation on the computer screen of a first object tracing the selected letter.

6. The method of claim 5, wherein the first object comprises a second image corresponding to a hand that moves along a path defined by the first image of the selected letter.

7. The method of claim 5, wherein the first image of the selected letter is displayed using a first color and wherein the first object comprises a third image of a region disposed within the first image of the selected letter, the third image being presented using a second color, different from the first color, being animated so as to give the appearance of beginning a starting location of the first image of the selected letter and growing along a path defined by the first image of the selected letter.

8. The method of claim 1, wherein the computerized interactive lesson is directed to teaching keyboard usage and wherein the presenting step comprises the steps of:
a. displaying on the computer screen an image of a maze defining a starting point and an ending point and a progress image that is initially disposed at the starting point;
b. receiving keyboard input, wherein each of a selected set of keys causes the progress image to move along the maze in a different selected direction; and
c. displaying an animation and sound combination once the progress image is moved to the ending point, thereby demonstrating successful completion of the maze.

9. The method of claim 1, wherein the computerized interactive lesson is directed to teaching letters and to teaching keyboard usage and wherein the presenting step comprises the steps of:
a. receiving a keyboard input of an input letter;
b. displaying an image of a balloon having a color that begins with the input letter;
c. receiving a keyboard input of an arrow key;
d. expanding the image of the balloon in response to the input of the arrow key until the image covers a preselected portion of the video screen, while substantially concurrently generating a first audio output that imitates a sound corresponding to expansion of the balloon; and
e. displaying a first animation of the balloon popping while generating a second audio output corresponding to the popping of a balloon.

10. The method of claim 9, further comprising the step of displaying an animation and sound combination after the step of displaying a first animation of the balloon popping, thereby demonstrating successful completion of the first animation.

11. A method of preventing drilling of a computer-based lesson, comprising the steps of:
a. determining an accumulated amount of time that a user has had access to the computer-based lesson; and
b. presenting the computer-based lesson to the user if the accumulated amount of time is less than a predetermined threshold, otherwise restricting the user from accessing the computer-based lesson.

12. The method of claim 11, further comprising the step of transmitting a message to the user indicating that the user no longer has access to the computer-based lesson if the accumulated amount of time is not less than a predetermined threshold.

13. A method of administering computer-based lesson presentment, comprising the steps of:
a. receiving a request for an computer-based lesson from a user via the global computer network;
b. resetting a current use timer having a timer value and periodically incrementing the timer value;
c. accessing an accumulated use memory, having an accumulator value; and
d. if the accumulator value is not less than a predetermined value, then restricting the user from accessing the computer-based lesson; and
e. if the accumulator value is less than the predetermined value, then repetitively performing the following steps:
i. presenting the computer-based lesson to the user;
ii. setting the accumulator value to the accumulator value plus the timer value; and
iii. determining if the accumulator value is not less than the predetermined value and, if the accumulator value is not less than the predetermined value then ending the computer-based lesson and restricting the user from accessing the computer-based lesson.

14. The method of claim 13, further comprising the steps of:
a. receiving a request from the user indicating that the user desires that the computer-based lessor be paused;
b. stopping the timer;
c. waiting for a request that the computer-based lesson be restarted; and
d. restarting the timer upon receiving a request that the computer-based lesson be restarted.

15. The method of claim 13, further comprising the steps of:
a. determining an amount of time that the user may continue to access the computer-based lesson; and
b. displaying the amount of time on a computer screen.

16. The method of claim 15, wherein the determining step comprises the step of setting the amount of time that the user may continue to access the computer based lesson to the predetermined value minus the accumulator value.
